(19) United States
(12) Patent Application Publication
(10) Pub. No.: US 2014/0255091 A1
(43) Pub. Date: Sep. 11, 2014

(54) STRUCTURE FOR CONNECTING LOWER PART PIPE AND UPPER PART PIPE OF FIXING POLE FOR ASSEMBLY FURNITURE

(71) Applicant: Neung Ho Ham, Gyeonggi-do (KR)

(72) Inventor: Un Hwan BAEK, Seoul (KR)

(73) Assignee: Neung Ho Ham, Gyeonggi-do (KR)

(21) Appl. No.: 14/197,410

(22) Filed: Mar. 5, 2014

(30) Foreign Application Priority Data
Mar. 7, 2013 (KR) 10-2013-0024554

(51) Int. Cl. F16B 12/40

(52) U.S. Cl. CPC F16B 12/40
USPC 403/345

(57) ABSTRACT

A structure for connecting lower and upper part pipes of a fixing pole for assembly furniture. Two to four cutout holes are selectively formed in an insertion part, which is formed at the upper portion of a lower part pipe, at a predetermined interval on the vertical lines thereof such that side surfaces which are not cut by the cutout hole expand to the outside and may prevent the upper and lower part pipes from moving in the right and left direction when the lower part pipe is coupled to the upper part pipe. A general fixing pole includes a lower part pipe additionally formed with an insertion part of a small diameter at the upper portion thereof, and an upper part pipe integrally coupled to the insertion part, the structure has a plurality of cutout holes which are formed in the insertion part on the vertical lines thereof.

### TECHNICAL FIELD

The present invention relates to a structure for connecting a lower part pipe and an upper part pipe of a fixing pole for assembly furniture and, more specifically, to a connection structure, wherein two to four cutout holes are selectively formed in an insertion part, which is formed at the upper portion of a lower part pipe on the vertical lines thereof such that side surfaces expand to the outside by the cutout holes and may prevent the upper part pipe and the lower part pipe from moving in the right and left direction without using any additional assembling tools when the lower part pipe is coupled to an upper part pipe.

### BACKGROUND

Assembly furniture has been widely used in general households in order to effectively utilize a narrow space.

Such assembly furniture is used for maintaining clothes or various kinds of daily necessaries by integrally coupling lathes, baskets or hangers to a fixing pole.

As shown in FIG. 5, a fixing pole 50 is one of the most essential constituents in the assembly furniture and includes a lower part pipe 20 and an upper part pipe 30 in a structure, in which the both pipes may be readily assembled so as to simplify the packing or transporting thereof.

The coupling of the lower pipe 20 and the upper part pipe 30, which form the fixing pole 50, are carried out using the insertion hole 15 formed in a small diameter at the upper portion of the lower part pipe 20, wherein the insertion hole 15 has the same diameter as the inner diameter of a hollow part 25 that is formed in the upper part pipe 30.

The insertion part 15 is inserted to the lower end portion of the upper part pipe 30, wherein a clearance is necessary between the outer diameter of the insertion part 15 and the hollow part 25 of the upper part pipe 30 so that the lower part pipe 20 and the upper part pipe 30 may move in the right and left direction after the assembling thereof as well as likely separate from each other, resulting in the considerable inconvenience in use.

Therefore, in order to resolve the problem, it is necessary that, after the upper portion of the insertion part 15 that is formed at the upper end portion of the lower part pipe 20 is inserted to the inside of the hollow part 25 of the upper part pipe 30, a bolt hole 31 is formed at one side of the lower end portion of the upper part pipe 30, and an additional bolt 32 or the like is fixed in the bolt hole 31 as a fastening member so as to fix the lower part pipe 20 and the upper part pipe 30 for stabilizing the assembling state thereof.

### SUMMARY

### Problems to be Solved by the Invention

Therefore, the present invention has been accomplished in order to resolve the above-mentioned and other disadvantages and problems, and an object of the present invention is to provide a structure for connecting a lower part pipe and an upper part pipe of a fixing pole for assembly furniture, which may prevent the upper part pipe and the lower part pipe from moving in the right and left direction without using any additional assembling tools when coupling the lower part pipe and the upper part pipe, which form the fixing pole, to each other.

### Means for Solving the Problems

In order to accomplish the above object, there is provided, in a fixing pole which includes a lower part pipe additionally provided with an insertion part of a small diameter at an upper portion thereof and an upper part pipe integrally coupled to the insertion part, a structure for connecting a lower part pipe and an upper part pipe of a fixing pole for assembly furniture is characterized in that cutout holes are formed in the insertion part of the lower part pipe on the vertical lines thereof.

In particular, the cutout holes formed in the insertion hole are maintained at a predetermined interval and selectively formed by the number of two to four.

### Effects of the Invention

According to the present invention as described hereinabove, the outside surfaces of the cutout holes slightly expand in the outward direction by forming the cutout holes in the insertion part on the vertical line thereof such that the outer diameter of the insertion part expands. Therefore, the upper part pipe and the lower part pipe are prevented from moving in the right and left direction without using any additional assembling tools as well as separating from each other.

### BRIEF DESCRIPTION OF THE DRAWINGS

The invention, together with further objects and advantages thereof, may best be understood by making reference to the following description taken together with the accompanying drawings, in which:

FIGS. 1a, 1b and 1c are perspective views illustrating the configuration of a structure for connecting a lower part pipe and an upper part pipe of a fixing pole for assembly furniture according to the present invention.

FIG. 2 is a cross-sectional view of the structure according to the present invention.

FIG. 3 is a plane view of FIG. 1c.

FIG. 4 is an expanded cross-sectional view illustrating the state that a lower part pipe and an upper part pipe are coupled to each other, and

FIG. 5 is a front view illustrating the assembled state of a prior art fixing pole.

### DETAILED DESCRIPTION OF THE INVENTION

Now, an exemplary embodiment of the present invention will be described in view of the configuration and operations of the present invention with reference to accompanying drawings.

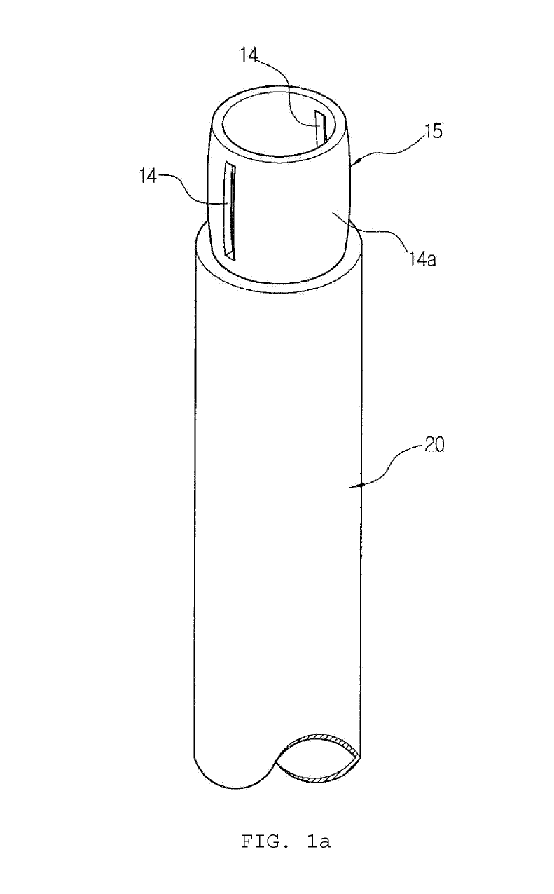

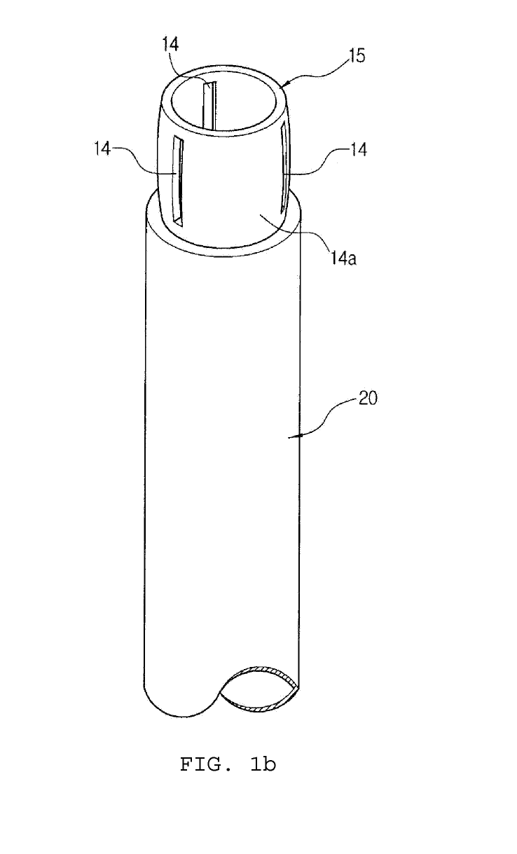

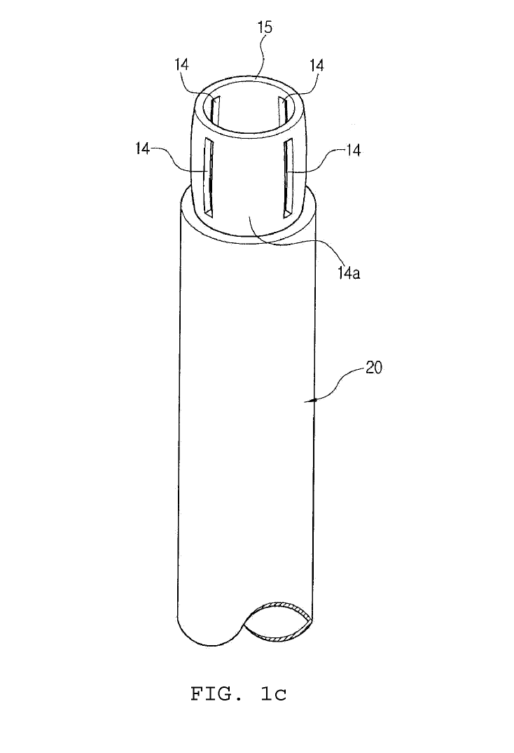

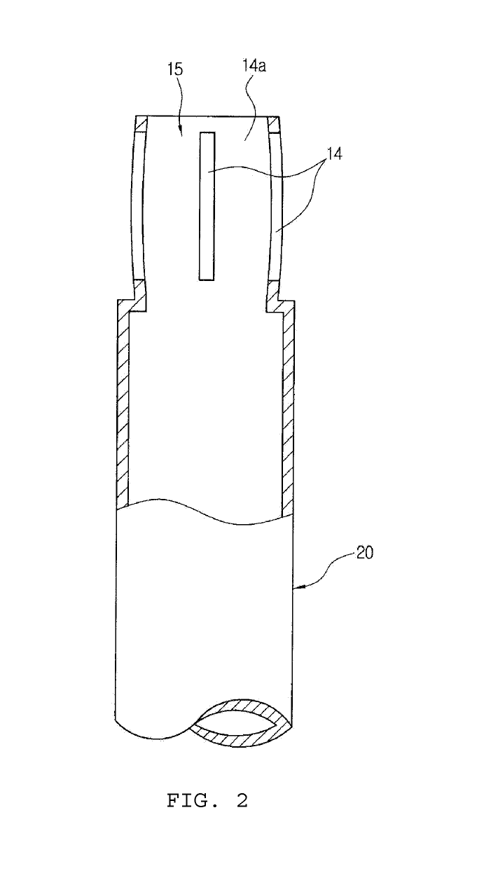

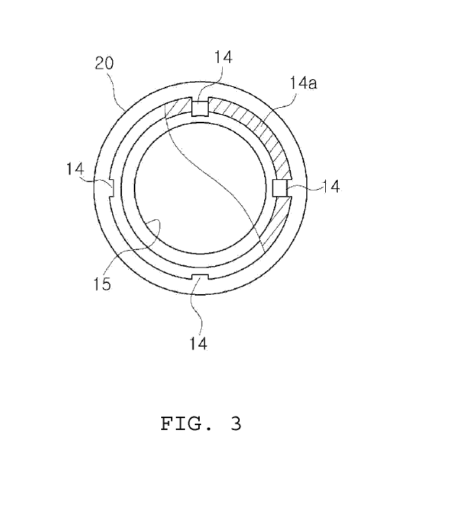

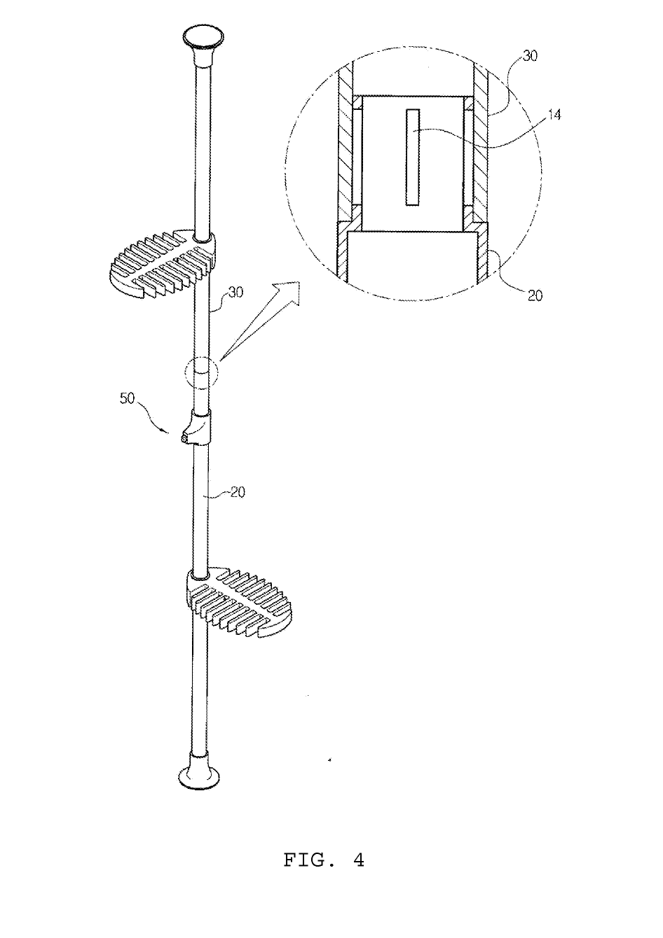

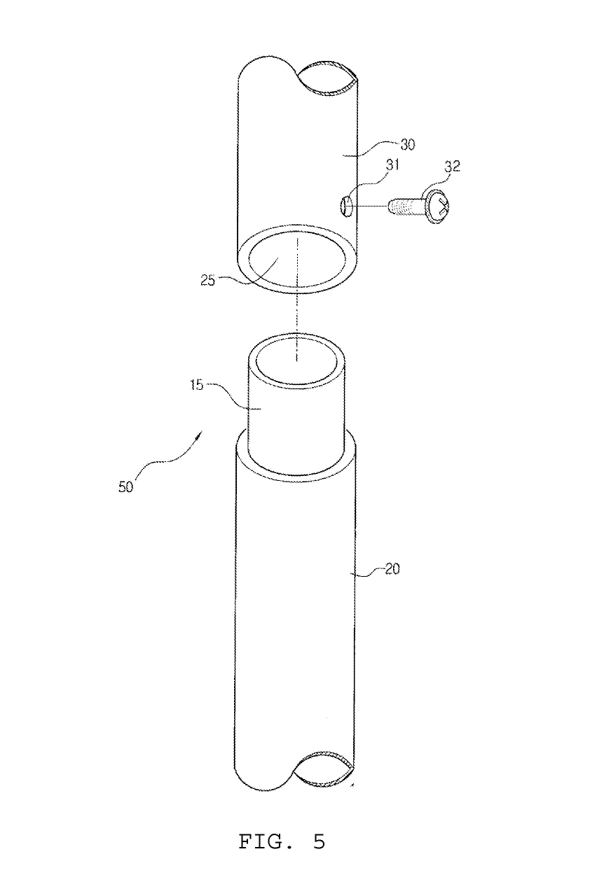

FIGS. 1a, 1b and 1c are perspective views illustrating the configuration of a structure for connecting a lower part pipe and an upper part pipe of a fixing pole for assembly furniture according to the present invention, FIG. 2 is a cross-sectional view of the structure according to the present invention, FIG. 3 is a plane view showing the section of a part of the structure of the present invention, and FIG. 4 is an expanded cross-sectional view illustrating the state that a lower part pipe and an upper part pipe are coupled to each other.

As shown in the accompanying drawings, the present invention pertains to a change of the structure of the fixing pole 50 which is widely used in assembly furniture.

That is, the present invention is derived from the material characteristics of the steel pipe which forms the fixing pole 50 in that if any one portion is cut out then a portion which is not cut out slightly expands to the outside by elasticity such that the outer diameter thereof slightly increases.

As shown in FIGS. 1a, 1b and 1c, in the structure according to the present invention, an insertion part 15 is provided at an upper portion of a lower part pipe 20 that forms the fixing pole 50, and two to four cutout holes 14 are formed in the insertion part 15 at a uniform interval on the vertical lines thereof, wherein the width of the cutout holes 14 is efficiently maintained in the range of about 2-3 mm. By forming a plurality of the cutout holes 14 in a small width as above, side surfaces 14a which are not cut may expand to the outside such that the side surfaces 14a between the cutout holes 14 expand swell to the outside so as to swell more than the diameter of the insertion part 15 as shown in FIG. 3.

Further, the side surfaces 14a which are formed between the cutout holes 14 that form the insertion part 15 slightly expand in diameter and can be also restored to the initial diameter thereof with flexibility if physical force is applied to the outside surfaces of the insertion part 15 by inserting the hollow part 25 of an upper part pipe 30 thereto from the upper portion of the insertion part 15 in the case of use.

In other words, after coupling the hollow part 25 formed on the upper part pipe 30 to the insertion part 15 of the lower part pipe 20, the outside portion of the insertion part 15 expands such that the diameter of the insertion part 15 becomes slightly larger than the diameter of the hollow part. Therefore, the coupling between the upper part pipe 30 and the lower part pipe 20 is carried out in a forced fitting manner.

As the upper part pipe 30 is coupled to the outside surface of the insertion part 15 as described hereinabove, expansion force is applied to the insertion part 15 in the outward direction thereof by the cutout holes 14 which are formed on the vertical lines of the insertion part 15.

The coupling between the outside surface of the insertion part 15 and the inside surface of the hollow part 25 is carried out in a forced fitting manner. Therefore, the upper part pipe 30 may be prevented from moving in the right and left direction even without using any additional assembling tools and the upper part pipe 20 may be prevented from easily separating from the lower part pipe 20.

Although the present invention has been described in detail by reference to the forgoing embodiments and accompanying drawings, the present invention is not limited thereto and it is apparent to those skilled in the art that various changes and modifications of the present invention maybe made without departing the spirit and scope of the invention.

### BRIEF EXPLANATION OF REFERENCE SIGNS

14: cutout hole

15: insertion part

20: lower part pipe

30: upper part pipe

50: fixing pole

What is claimed is:

1. In a fixing pole which includes a lower part pipe additionally provided with an insertion part of a small diameter at an upper portion thereof and an upper part pipe integrally coupled to the insertion part, a structure for connecting a lower part pipe and an upper part pipe of a fixing pole for assembly furniture is characterized in that cutout holes are formed in the insertion part of the lower part pipe on the vertical lines thereof.

2. The structure for connecting a lower part pipe and an upper part pipe of a fixing pole for assembly furniture according to claim 1, wherein the cutout holes formed in the insertion hole are maintained at a predetermined interval and selectively formed by the number of two to four.
